(19) United States
(12) Patent Application Publication
(10) Pub. No.: US 2019/0065593 A1
(43) Pub. Date: Feb. 28, 2019

(54) Distributed Ledger Registry System

(71) Applicant: Forward Blockchain, LLC, Evanston, IL (US)

(72) Inventor: Conrad Barski, Evanston, IL (US)

(21) Appl. No.: 15/822,055

(22) Filed: Nov. 24, 2017

Related U.S. Application Data
(60) Provisional application No. 62/551,163, filed on Aug. 28, 2017.
(60) Provisional application No. 62/562,192, filed on Sep. 22, 2017.

(51) Int. Cl. G06F 17/30

(52) U.S. Cl. CPC G06F 17/30861; G06F 17/30002

(57) ABSTRACT

Disclosed herein is a registry system driven by a distributed ledger rather than a client-server-database model. In accordance with an embodiment, an example method includes establishing, on a distributed ledger, a permissions contract containing program code associated with user permissions for modifying the registry data; establishing, on the distributed ledger, a regulations contract containing program code associated with requirements for modifying the registry data, establishing, on the distributed ledger, a storage contract containing registry data and program code. The storage contract contains program code executable to cause a computing device to execute the permissions contract to determine that a given user is permitted to make the given type of modification to the registry data in the storage contract, execute the regulations contract to determine whether the given type of modification to the registry data is permitted, and modify the registry data in the storage contract in accordance with a request.

### CROSS-REFERENCE TO RELATED APPLICATIONS

This application claims priority to U.S. provisional application No. 62/562,192 filed Sep. 22, 2017 and to U.S. provisional application No. 62/551,163 filed Aug. 28, 2017, the entire contents of both of which are incorporated herein by reference in their entireties.

### BACKGROUND

Throughout the world, including in the United States, certain industries are regulated by public organizations (e.g., government agencies) and/or private organizations (e.g., trade groups). Regulated industries often have certain requirements for their participants. If those participants meet those requirements, they are said to be “licensed.”

In the healthcare industry, for instance, there are rules governing license requirements for healthcare professionals. In order to be licensed, a healthcare professional may be required to satisfy several requirements, such as education credits, fees, and updated registration paperwork.

Additionally, in the healthcare industry, there are rules governing the licensing (i.e., validation) of healthcare equipment. For instance, in order to be operated for intended purposes, some healthcare equipment must be maintained and inspected according to industry requirements. Other examples of regulated industries, regulated professionals, and regulated things exist.

Moreover, throughout the world, both public organizations and private organizations are often interested in registering and tracking the status of people or things relevant to their activities. This may be done according to the particular interest of the organization and according to rules and/or standards developed by the organization for its own purpose. As one example, a medical hospital may register and track equipment (e.g., hospital beds, among other examples) throughout its facility. As another example, bike-sharing service may register and track bikes as they are checked-out and checked-in within a given city. Other examples exist.

### Overview

To keep track of registration requirements for regulated industry participants, registry systems are typically employed. Modern registry systems are typically arranged in what are known as client-server-database models. Client-server-database models often implement what is sometimes referred to as a “three tier system” for management of access permission and control. In such models, a database server houses registry data, including data describing the registrants (e.g., the names and address of registered healthcare professionals, in a healthcare registry system), data describing the registry rules (e.g., requirements for obtaining or renewing a license for a healthcare professional, in a healthcare registry system), and data describing access rules (e.g., user permissions indicating who is permitted to make changes to the data). In practice, client systems access the database server (to add or change data associated with a registrant) though a separate application server that authenticates users and processes their requests.

In a typical scenario, a client may first send a session establishment request to the application server. The application server authenticates this client by establishing its own secure session with the database server to determine whether the client has appropriate permissions to engage in the requested session. If the client has appropriate permissions, then the application server establishes a long-term communication session with the client. The client may, at that point, send a request to the application server that changes the contents of the database in some way (e.g., renews the license of a healthcare professional for an additional year). Responsively, the application server may further validate the client's permissions, and if permitted, transmit the requested transaction to the database server.

The client-server-database registry system has several drawbacks, however. First, because the server side of the client-server model is generally deployed and managed by a single organization, it amounts to a single point of failure. For instance, any downtime by either the database server or the application server may result in downtime for the entire system. Moreover, client-server systems are prone to attacks at the server level, such as “Denial of Service” attacks or other malicious security breaches, which threaten users' privacy as well as the integrity of the registry data.

Second, three-tier systems often struggle with handling user disambiguation and two-factor authentication. For instance, to disambiguate two users with the same identifier, the system will typically store additional personally identifiable information (PII), such as an email address, birthdate, social security number, etc. Maintaining PII renders the system vulnerable to attack and increases the users' risk of having such PII compromised. Additionally, two-factor authentication adds complexity to the server programming, which increases costs.

Third, the three-tier model is inefficient at handling complex user requests. For instance, in a situation in which a user, or even multiple users, make many requests at or near the same time, implementing such requests can put the database in an undefined state, which may prevent further requests from being processed appropriately. One attempt to deal with this situation is to implement batch processing. But this tends to be problematic for two reasons. One: batch processing may lead to concurrency problems, race conditions, and deadlocks. And two: the programming associated with enabling batch transactions tends to be complex. This leads to increased costs associated with initial deployment and maintenance, and also leads to increased vulnerability. As a general matter, the more complex application code is, the more vulnerable it is to exploit. This vulnerability tends to exacerbate the above-described drawbacks. Other drawbacks exist as well, such as excessive infrastructure costs associated with managing a server and database, among others.

Disclosed herein is an improved registry management system that helps overcome the aforementioned drawbacks. The disclosed registry management system is described herein, by way of example and not limitation, as a registry system for tracking entity registration in a government-regulated industry, such as healthcare. For example, the disclosed registry system may be used to store, update, and provide access to any or all of: the licensed statuses of healthcare professionals, facility accreditations, and equipment inspection reports. But those of skill in the art should appreciate that the disclosed methods and systems may be applicable to other types of registry management systems, and even other types of data-management systems altogether.

Indeed, the features and functionality of the present disclosure may be applied to data-management systems other than registry systems. For example, the features and functionality may be deployed as any or all of: an inventory management system, usable for instance, by a merchant or a shipping operation; an employee and/or payroll database; a ticketing system for management of ticket sales, usable for instance, by a venue hosting a concert, performing arts, or sports function, or by a common carrier, such as an airline, ground transportation operation, or sea farer; an enrollment management system, usable for instance by a University, public or private secondary school, or any system for managing assets, registrations, bookings, enrollments, or statuses; a supply chain management system, usable for instance, by a drug manufacturer for managing the ingredients of a given manufactured medication; a protocol management system, usable for instance, by a medical provider to manage the protocols for care administered to patients; a data conditioning system, usable for instance, by an organization that endeavors to collect and curate data for use in machine learning applications; among other examples.

For the sake of brevity, the features and functionality of the present disclosure will be described herein by way of example to a government registry system; but those of skill in the art should understand that the present disclosure is applicable to any or all of the foregoing examples as well as any others that are or may become apparent to those of skill in the art having the benefit of the present disclosure. In accordance with one embodiment of the present disclosure, the registry system is deployed as a distributed ledger, virtual machine-based registry system. In such a system, the core functions of the registry system are separated and programmed into discrete computer programs, referred to as contracts (or smart contracts), which are stored and executed on the distributed ledger to carry out the registry functions.

As a general matter, a distributed ledger is a data structure that may be used by multiple entities to store data records, such as financial transactions or the output of computer code execution. Some implementations of distributed ledger systems are arranged so that they can store tamper-resistant records of previously-verified transactions or computer code execution. For instance, distributed ledger schemes, such as Bitcoin and Ethereum, utilize public distributed ledgers to record and verify transactions between users.

One example of a distributed ledger is a blockchain. A blockchain is a series of data structures, referred to as blocks. Each block contains a set of one or more data records and a header. The header includes a hash derived from the contents of the data records of the given block. Each subsequent block in the blockchain includes, in its header, the hash of the previous block as well as the hash derived from its own contents (i.e., the data records in the block).

FIG. 1 depicts a portion 100 of an example blockchain. As depicted, portion 100 includes at least three blocks 101, 102, and 103. Each block includes a respective header 110, 120, and 130, and data records 113, 114, 115, 123, 124, 125, 133, 134, and 135. Although only three records are shown with each example block, those skilled in the art will realize that each block will in practice typically contain more than three records (although fewer are possible too), and no block need necessarily include the same amount of records. As mentioned, each header contains a hash derived at least from the data records contained in the block. Thus, hash 112 of block 101 is derived at least from records 113-115; hash 122 of block 102 is derived at least from records 123-125; and hash 132 of block 103 is derived at least from records 133-135. Each header also contains a copy of the hash of the previous block. Thus hash 111 is a copy of the hash of the block immediately preceding block 101; hash 112 in header 120 is a copy of hash 112 in header 110; and hash 122 in header 130 is a copy of hash 122 in header 120.

This arrangement prevents any subsequent modification to the contents of earlier blocks in the blockchain. Indeed, any change to the data records of previous blocks in a blockchain would render the hashes in such previous blocks incorrect. And because each block in the blockchain links back to the previous block, one change to a single data record in any block would render each hash of each subsequent block incorrect. This helps to ensure the consistency of the data structure and the security of the data records in the blockchain.

In some implementations, a distributed ledger, such as a blockchain, may be used to store financial transactions. As mentioned, the distributed ledger schemes, Bitcoin and Ethereum, use a blockchain to record transactions between Bitcoin users.

But in other implementations, a distributed ledger may include or be used as a decentralized application platform, which supports, among other things, execution of computer code and storage of data. These types of distributed ledgers may also be implemented using a blockchain, but instead of recording financial transactions, the blockchain records state changes of a virtual machine, which are caused by execution of computer programs written for the virtual machine. These computer programs are referred to as “contracts” and are given an address and recorded in the blockchain. The program code that makes up a contract cannot be changed without destroying the integrity of the entire blockchain. As such, these contracts are more secure and immutable than traditional computer programs.

Indeed, the security and immutability of such distributed ledgers is illustrated by the failure to compromise the Bitcoin public blockchain. Consider that, at the time of filing, the potential reward of compromising the Bitcoin blockchain would be on the order of $100 Billion in Bitcoin value, yet the Bitcoin blockchain has been without any such compromise. In a similar was, the Ethereum blockchain has not seen a compromise threatening the currency (Ether) overlaying that blockchain. And, indeed, this is generally the case for any distributed ledger system, public or private, arranged in accordance with the present disclosure.

To maintain a distributed ledger system across a public peer-to-peer network, transactions are typically published to participating entities, referred to as nodes. FIG. 2 depicts an example arrangement (discussed in further detail herein below) of nodes that may maintain a distributed ledger. Generally, nodes 201, 202, and/or 203 receive, through the communication network(s) 250, additions (such as desired transactions) to the distributed ledger, and separately build these additions into the respective stored copies of the ledger. Each node may then publish the resulting ledger to the other nodes for confirmation. In this way, each participating entity can verify new transactions by examining the contents of the blockchain and confirming that each block's hash is appropriately matched. In some embodiments, the ledgers maintained by the individual nodes are identical. This identicality is referred to as consensus.

FIG. 3 depicts a portion 300 of an example distributed ledger that may be used as a decentralized application platform. As depicted, portion 300 includes at least three blocks 301, 302, and 303. Like the blockchain portion depicted in FIG. 1, each block depicted in FIG. 3 includes a respective header 310, 320, and 330. Each block also includes transactions, 313, 323, and 333, account lists 314, 324, 334 and the current state of the virtual machine 315, 325, and 335. In decentralized application distributed ledger systems, there are generally two types of accounts. An account that contains a type of cryptocurrency, such as Bitcoin for the Bitcoin distributed ledger, or Ether for the Ethereum distributed ledger; and an account that contains program code, referred to as a “contract.” Account list 314 is depicted as containing multiple accounts, including at least contracts 342 and 344. Contract 342 is depicted as containing program code 352 and data storage 354 associated with the contract 342.

It should be understood that, although data storage 354 in FIG. 3 is depicted as traditional data storage, data storage 354 (as well as other similar data storage elements described elsewhere herein) may be, in practice, implemented as virtual data storage. In other words, data storage 354 may not, in practice, be a database or other traditional storage model; rather, data storage 354 may be implemented as readable/writable portion of the distributed ledger on which the host contract resides. Alternatively or additionally, data storage 354 may be a portion of data storage (e.g., a hard disk or solid-state drive) of one or more the individual nodes maintaining the ledger on which the host contract resides. Still alternatively or additionally, data storage 354 may be implemented as data storage residing outside of the distributed ledger on which the host contract resides, including, by way of example, as cloud storage or another remotely-located data storage application.

Contracts, such as contract 342, may be established in any number of ways, including for instance, by sending a copy of the program code into the distributed ledger, where the processing nodes (e.g., node 201) encodes the contract into the ledger at the next available address. Contracts are invoked by sending a message to the contract's address. When a contract is invoked, the computer code in the contract executes and makes a change to the virtual machine (e.g., moves cryptocurrency from one account to another account, or reads data from or writes data to storage (e.g., data storage 354) dedicated to the contract). After this change, the virtual machine exists in a new state. And it is this virtual machine state that is recorded in the blockchain.

Again, by way of example, as depicted, block 301 contains a list of certain transactions 313, which may include transfers of cryptocurrency from one account to another and/or calls to various contracts. The state of the virtual machine after all transactions are executed (including cryptocurrency transfers and contract code executions) is set forth in state 315. All nodes participating in the distributed ledger network (e.g., nodes 201, 202, and/or 203, described further herein) should, after executing the transactions 313, produce identical states. One example of a public distributed ledger utilizing a decentralized application platform with native smart contract functionality, such as that just described, is Ethereum, although other examples are possible as well.

To help facilitate the security and immutability discussed briefly above, some distributed ledgers, such as Ethereum, employ a “limited operation” feature. This feature operates to specify a limit on the number of operations a particular contract can engage in. The operation limit is typically specified by the entity calling the contract, and when the operation limit is reached by the entity executing the contract, such execution halts, even if the functions specified by the program code were not completed. An operation typically has a cost associated with it. The cost is paid by the entity calling the contract and is paid to the entity executing the contract and is typically paid in the currency overlaying the distributed ledger. Having a cost associated with each operation of a contract may serve to mitigate the threat of distributed denial of service attacks because such attacks would be prohibitively expensive.

In Ethereum, this “limited operation” feature is referred to as “gas.” In operation, each transaction or message published to the Ethereum network has a desired amount of “gas” and a “gas price.” In some examples, the originator of the transaction or message can specify the amount of gas and the gas price. Each operation engaged in as a result of the transaction or message deducts one unit of “gas” multiplied by the “gas price” in the form of Ether from the originator's account. Once the gas runs out, execution halts. As described, this helps to mitigate users from occupying the processing power of nodes for inordinate amounts of time.

In some cases, for instance, distributed ledgers, like those described briefly above, are private, meaning the ledgers (e.g., the blockchain or other type of ledger) is built, maintained, and added to by only certain participating entities. However, given that the nature of these ledgers, particularly blockchains, renders the data recorded therein immutable, they can be built, maintained, and added to by a distributed peer-to-peer network of computers (e.g., nodes 201, 202, and 203, described further herein) with little risk to security comprise. Distributing the ledger in a public public-peer-to-peer network has several advantages over running a central server, including increased data redundancy and offloading computation from a single point of failure.

Returning now to the registry system of the present disclosure, in accordance with one embodiment, the functionality of the registry system is spread out across multiple contracts, which are stored and executed on a distributed ledger, such as Ethereum. More specifically, but still by way of example, the disclosed registry system may have a first set of rules related to account hierarchy permissions encoded and stored in a first set of contracts. Account hierarchy permissions, may define the roles and permissions of the many users of the registry system. In one respect, a medical services provider, such as a hospital, ought to be permitted to modify only registry data associated with that medical services provider. In another respect, a continuing education provider ought to be permitted to modify registry data of many entities for which the continuing education provider offers continuing education. Thus, this first set of contracts (referred to as permissions contracts) would set forth the many permissions of the registry system.

The disclosed registry system may also have encoded in a second set of contracts a second set of rules related to government or another regulatory body's regulations that define how and when registration occurs. For instance, a local or federal government or other regulatory body may set forth a regulation requiring a healthcare professional to receive a particular set of continuing education credits in order to renew his or her license. As well, a local or federal government or other regulatory body may set forth that certain medical equipment undergo a number of maintenance hours per period in order to be licensed to operate. Thus, this second set of contracts (referred to as regulation contracts) would set forth the many regulations used by the registry system.

In some additional embodiments of the present disclosure, the distributed ledger-based registry system may further include a storage contract that contains or points to an address of the many entries that make up the registry. This storage contract may also contain the instructions on how to access the rules in the permissions contract(s) and the rules in the regulation contract(s). For instance, in one example, the storage contract may be associated with a data storage location on the distributed ledger. This data storage location may contain the addresses of the one or more permissions contracts and the addresses of the one or more rules contracts.

In some implementations, the contents of this data storage may be changed by a user with appropriate permissions. Thus, while the code of the actual storage contract would not be able to change once encoded onto the distributed ledger, the data storage associated with that storage contract would be able to be changed. As such, and in accordance with this embodiment, in a situation where government regulations change or it is desired to change user permissions, a new permissions contract or a new regulations contract could be encoded onto the distributed ledger and the data storage associated with the storage contract modified to point to the address of the new permissions contract or a new regulations contract. In this way, the registry system disclosed can advantageously utilize the secure and permanent nature of a distributed ledger system, yet facilitate changing permissions and changing regulations.

Also disclosed herein is an example user interface system that may be used to access the distributed ledger registry. Implementing a registry system with a distributed ledger in accordance with the foregoing presents certain challenges for interacting with the registry data. In one example, storage in a contract may not be optimized for maximum client utility. Distributed ledger contracts are typically constrained by transaction cost and blockchain storage. In another example, blockchain queries tend to be asynchronous in nature. Most client requests tend to require large numbers of queries to fulfill any data request due to the inherently complex layout of data.

Addressing these limitations, disclosed herein are example systems and processes that help a user interface implement multitasking and complex data transformation on blockchain query results. The architecture of these example systems and processes include a client model and a distributed ledger parser. In one example, the client model utilizes several client views. When a model receives requests that are dependent on distributed ledger-side data, it has handlers that describe the data via graph queries, which are an efficient data query format that allow for deeply nested requests involving multiple nested client components that make up views of the data presented to the user.

In another example, to fulfill graph query requests, the user interface client contains query parsers and subquery parsers that resolve the query against the distributed ledger. Each subquery is a handler for a fragment of the larger query. These subqueries may be processed in parallel, which may achieve increased user interface responsiveness.

Thus, in accordance with example embodiments disclosed herein, the functions of the registry system are driven by a few contracts executable on a distributed ledger system, rather than driven by a client-server-database model. In this way, the disclosed registry system is insulated against denial of service attacks or other malicious breaches. In addition, the core rules are separated from any program providing a user interface. This further insulates the registry from points of attack.

In more particular examples of the present disclosure, provided herein is a system. The system includes a computing device containing one or more processors and non-transitory data storage. The non-transitory data storage contains a portion of a distributed ledger, which contains a storage contract containing registry data, a permissions contract containing program code associated with user permissions for modifying the registry data, and a regulations contract containing program code associated with requirements for modifying the registry data. The program code, when executed by the computing device, causes the computing device to execute the permissions contract to facilitate a determination that a given user is permitted to make a given type of modification to the registry data in the storage contract, execute the regulations contract to facilitate a determination that the given type of modification to the registry data is permitted, and modify the registry data in the storage contract in accordance with a modification requested by the given user.

Also provided herein is a non-transitory computer readable medium having program code stored thereon. The program code, when executed by a computing device, causes the computing device to carry out operations including facilitating access to a distributed ledger, the distributed ledger containing a storage contract containing registry data, a permissions contract containing program code associated with user permissions for modifying the registry data, and a regulations contract containing program code associated with requirements for modifying the registry data, receiving, from a client station, a request of a given user to make a given type of modification to registry data, facilitating execution of the permissions contract to determine that the given user is permitted to make the given type of modification to the registry data in the storage contract, facilitating execution of the regulations contract to determine whether the given type of modification to the registry data is permitted, and facilitating modification of the registry data in the storage contract in accordance with the received request.

Also disclosed herein is a method, which includes establishing, on a distributed ledger, a permissions contract containing program code associated with user permissions for modifying the registry data; establishing, on the distributed ledger, a regulations contract containing program code associated with requirements for modifying the registry data, establishing, on the distributed ledger, a storage contract containing registry data and program code, which when executed by a computing device would cause the computing device to execute the permissions contract to determine that a given user is permitted to make the given type of modification to the registry data in the storage contract, execute the regulations contract to determine whether the given type of modification to the registry data is permitted, and modify the registry data in the storage contract in accordance with a request.

These as well as other aspects and advantages will become apparent to those of ordinary skill in the art by reading the following detailed description, with reference where appropriate to the accompanying drawings. Further, it should be understood that the embodiments described in this overview and elsewhere are intended to be examples only and do not necessarily limit the scope of the claims.

### BRIEF DESCRIPTION OF THE DRAWINGS

FIG. 1 is a simplified block diagram of an example portion of a distributed ledger in accordance with one embodiment.

FIG. 2 is a simplified block diagram of an example arrangement of nodes in accordance with one embodiment.

FIG. 3 is a simplified block diagram of an example portion of a distributed ledger in accordance with one embodiment.

FIG. 4 is a flow chart depicting functions that can be carried out in accordance with one embodiment.

FIG. 5 is a simplified block diagram of an example arrangement of contracts in accordance with one embodiment.

FIG. 6 is a flow chart depicting functions that can be carried out in accordance with one embodiment.

FIG. 7 is a simplified block diagram of an example arrangement of contracts in accordance with one embodiment.

FIG. 8 is a message-flow diagram depicting an example message flow in accordance with one embodiment.

### DETAILED DESCRIPTION

In the following detailed description, reference is made to the accompanying figures, which form a part hereof. In the figures, similar symbols typically identify similar components, unless context dictates otherwise. The illustrative implementations described in the detailed description, figures, and claims are not meant to be limiting. Other implementations may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

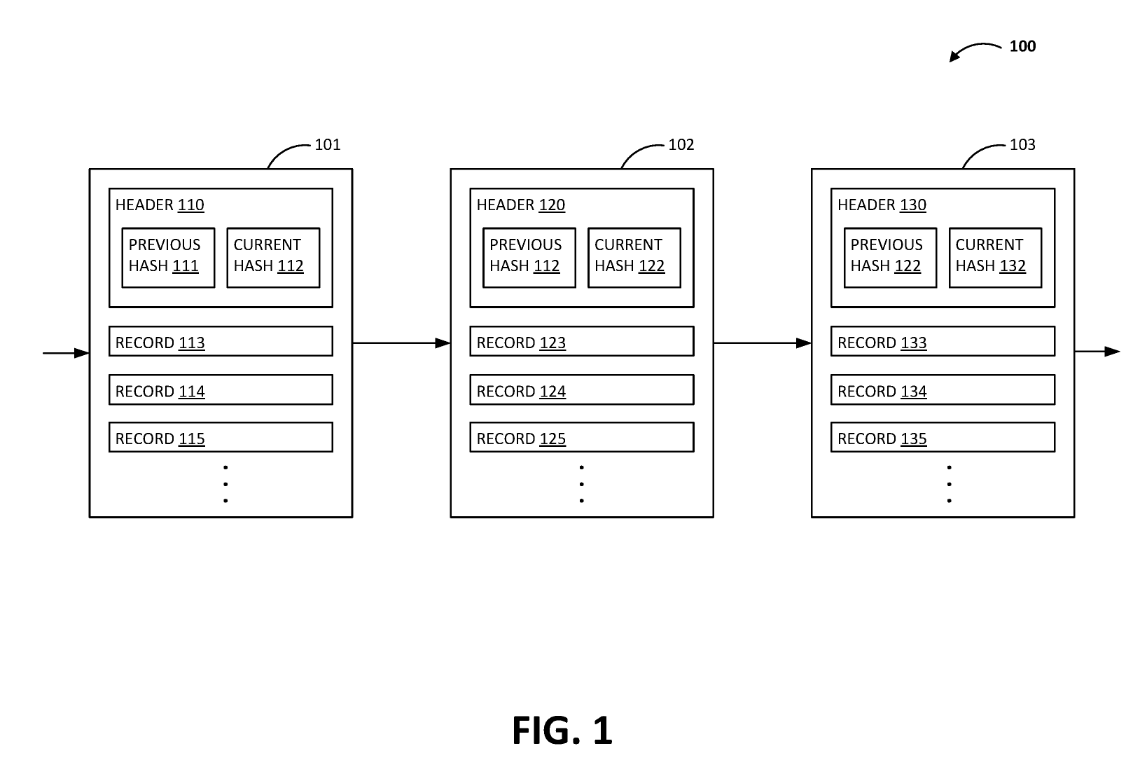

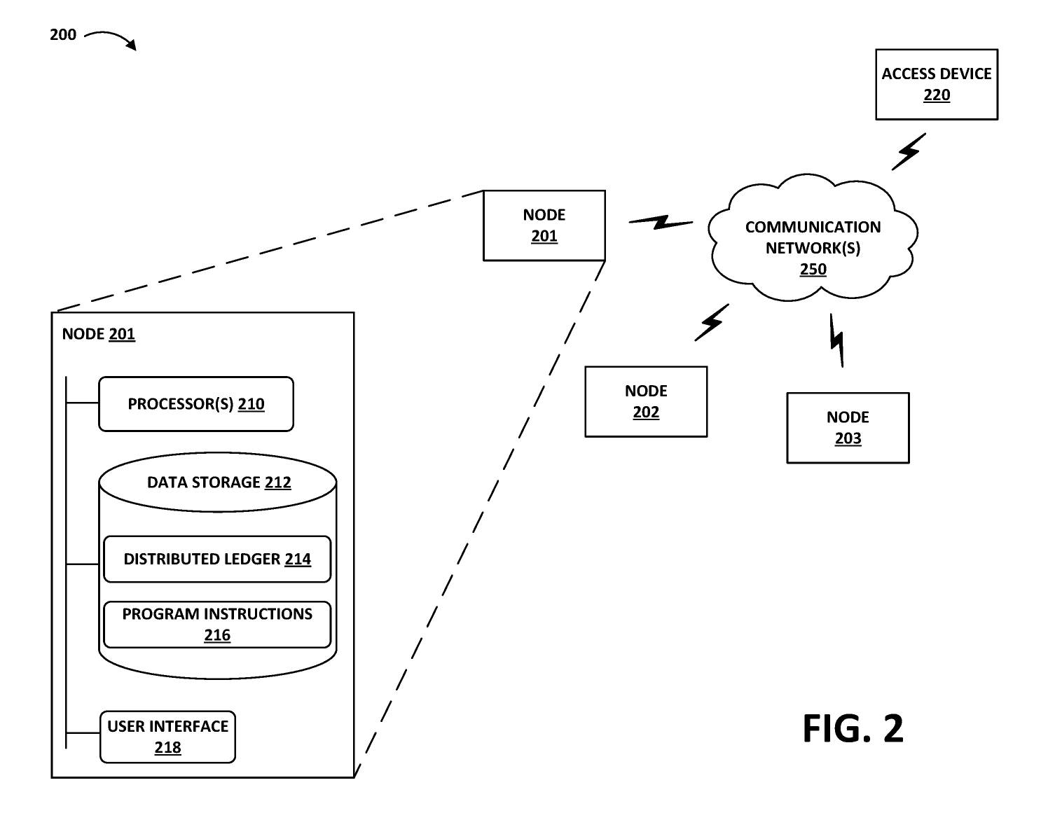

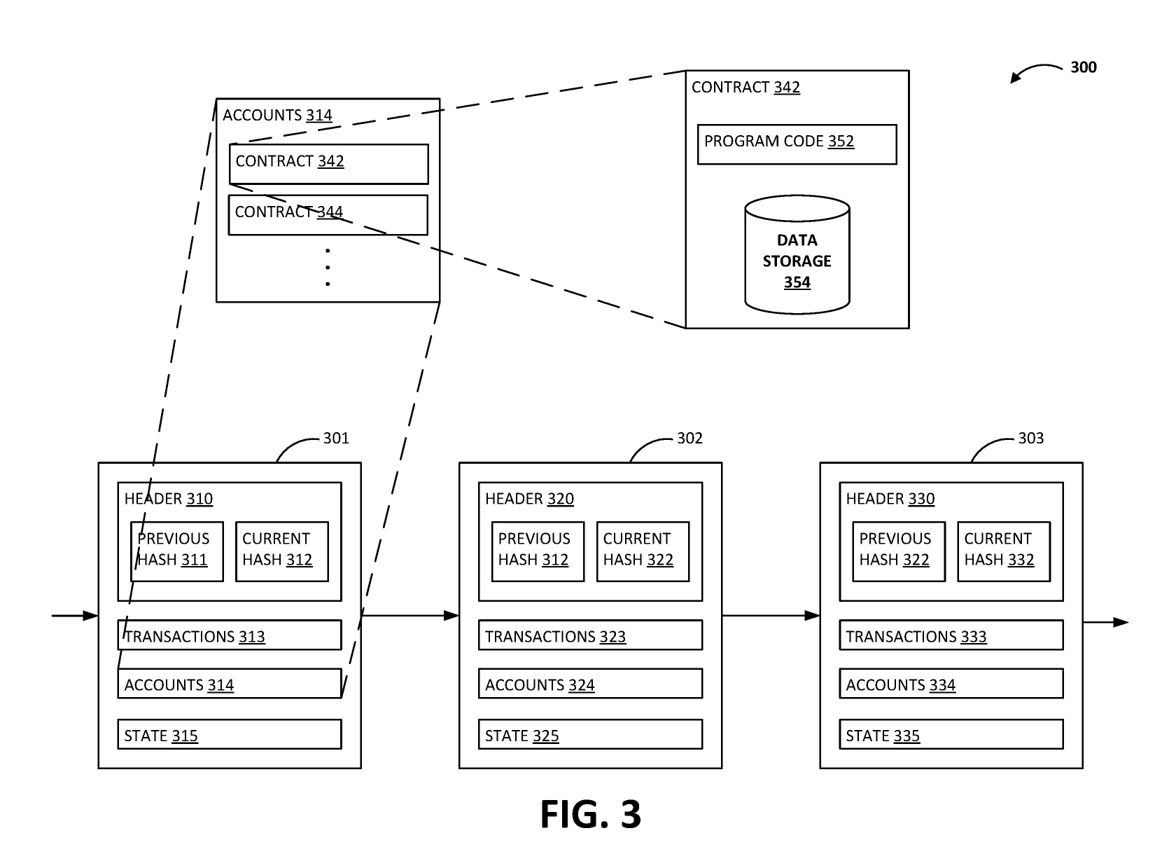

In order to maintain and add to a distributed ledger, such as the distributed ledger depicted in FIG. 1 and/or FIG. 3, one or more computing devices, referred to as nodes, typically store and add to the ledger. As mentioned briefly above, FIG. 2 depicts an example arrangement 200 of nodes 201, 202, and/or 203 that may maintain a distributed ledger, such as the distributed ledgers described by way of example herein. Although FIG. 2 depicts three nodes, 201, 202, and 203, it should be understood that in practice, more or fewer nodes could be used. For instance, at the time of filing, it is estimated that about 12,000 nodes currently participate in the Bitcoin blockchain.

Also depicted in arrangement 200 is an access device 220. Access device 220 may be a computing device that has access to and may publish transaction destined for the distributed ledger, but may not necessarily store, add to, or otherwise maintain the distributed ledger.

As further depicted, nodes 201, 202, and 203 and access device 220 are communicatively coupled to one or more communication networks 250, such as the Internet. Through communication network(s) 250, the nodes are able to receive publications of transactions from other computing devices, such as access device 220, and add those transactions to the relevant distributed ledger. To facilitate this, node 201 includes or otherwise has access to a processor or processors 210, data storage 212, which includes therein a copy of the entire distributed ledger, or a relevant portion thereof, and program instructions 216, and a user interface 218. Note that the components associated with node 201 are shown for illustration purposes only and may include additional components and/or have one or more components removed without departing from the scope of the disclosure. Further, note that the various components of node 201 may be arranged and connected in any manner.

Processor(s) 210 may be general-purpose processors or a special purpose processor (e.g., digital signal processors, application specific integrated circuits, etc.). The processor(s) 210 can be configured to execute computer-readable program instructions 216 that are stored in the data storage 212 and are executable to provide the functionality described herein. For instance, the program instructions 216 may be executable to provide for receiving transactions, encoding the transactions into a distributed ledger 214, and publishing the distributed ledger 214 to the other nodes, if any. The program instructions 216 may be executable to carry out all or part of the other operations described herein.

The data storage 212 may include or take the form of one or more computer-readable storage media that can be read or accessed by the one or more processors 210. The one or more computer-readable storage media can include volatile and/or non-volatile storage components, such as optical, magnetic, organic or other memory or disc storage, which can be integrated in whole or in part with the one or more processors 210. In some implementations, the data storage 212 can be implemented using a single physical device (e.g., one optical, magnetic, organic or other memory or disc storage unit), while in other implementations, the data storage 212 can be implemented using two or more physical devices. Further, node 201 may also include a user interface 218, which may include such components that enable a user to interact with the node 201, such as a display, user input device, and program instructions for presenting a graphical user interface (GUI) to the user so that a user can provide input to the node 201. Although the forgoing has been described with reference to node 201, the other nodes in the system, such as nodes 202 and 203, as well as the access device 220, may have the same or similar computing components.

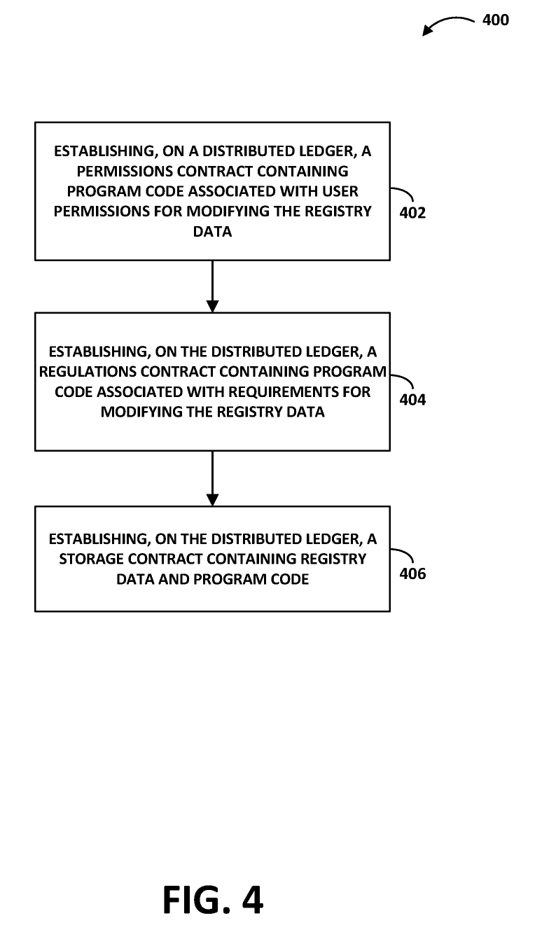

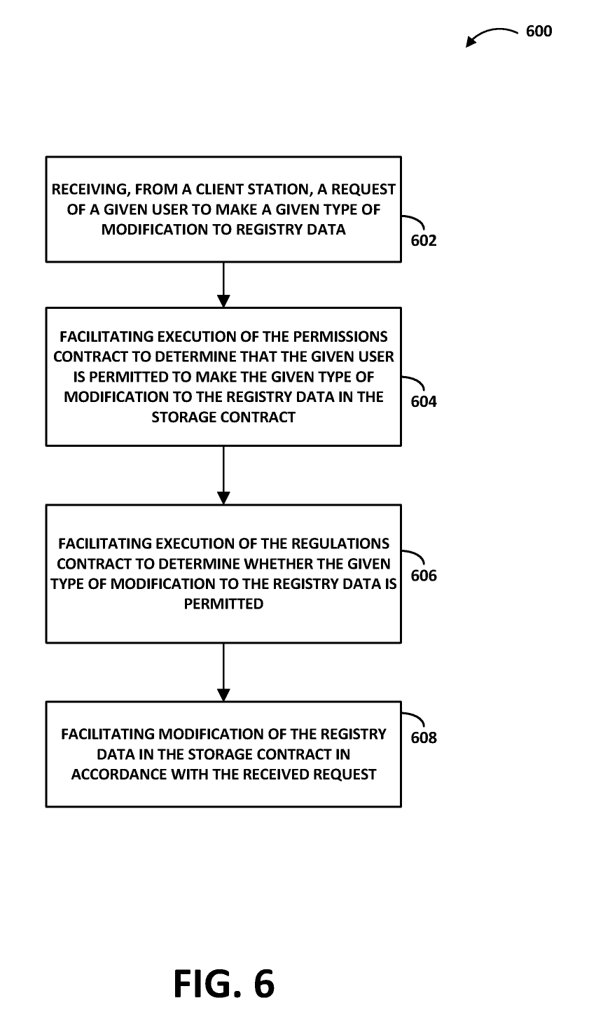

FIGS. 4 and 6 are flowcharts of example methods 400 and 600 in accordance with embodiments of the present disclosure. The example methods 400 and 600 may include one or more operations, functions, or actions, as depicted by one or more of blocks 402, 404, 406, 602, 604, 606, and/or 608, each of which may be carried out by any of the systems described by way of FIGS. 1, 2, 3, and 5; however, other configurations could be used.

Furthermore, those skilled in the art will understand that the flowcharts described herein illustrate functionality and operation of certain implementations of the present disclosure. In this regard, each block of each flow diagram may represent a module, a segment, or a portion of program code, which includes one or more instructions executable by a processor (e.g., the processor(s) 210) for implementing specific logical functions or steps in the process. The program code may be stored on any type of computer readable medium, for example, such as a storage device including a disk or hard drive (e.g., data storage 212). In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as would be understood by those reasonably skilled in the art.

Turning first to FIG. 4, method 400 includes steps depicted by blocks 402, 404, and 406, which, in one implementation, establish a distributed ledger registry system. Beginning at block 402, method 400 includes establishing, on a distributed ledger, a permissions contract containing program code associated with user permissions for modifying the registry data. Establishing a contract on a distributed ledger may be accomplished in a variety of different ways. By way of example, in embodiments in which the distributed ledger network is Ethereum, establishing a contract includes publishing a transaction to the Ethereum network, where the transaction contains the program code of the contract. In other distributed ledger networks, other ways of establishing a contract are possible.

As a general matter, the permissions contract may serve to validate users and requests to access or modify the registry data. To that end, the permissions contract includes program code associated with user permissions for modifying the registry data. In one implementation, user permissions may take the form of a list of users and an associated list of access permissions of those users. For instance, user permissions may include an indication or indications that:
“User A” is permitted to read registry data, but not manipulate registry data;
“User B” is permitted to read and manipulate registry data; and
“User C” is not permitted to read or manipulate registry data.
   Additionally or alternatively, user permissions may be specified at varying levels of granularity with respect to the registry data. For instance, the user permissions may specify that certain users have one set of permissions for certain types of registry data, yet have other, perhaps different, permissions for other types of registry data. Other examples of user permissions are possible as well.

As mentioned, the permissions contract contains program code associated with the user permissions. In one implementation, the program code may contain instructions for determining (or facilitating a determination by another computing device (e.g., node 201)) whether a given user is permitted to access or modify certain registry data. More specifically, but still by way of example, the program code may be executed by a computing device (e.g., node 201) to receive an indication of a given user (e.g., “User A”) and a given request to access or modify certain registry data. The program code may be further executed by the computing device to make a determination, based on the user permissions, whether the given user is permitted to access or modify the registry data in accordance with the request. Other functions are possible as well.

Continuing at block 404, method 400 includes establishing, on the distributed ledger, a regulations contract containing program code associated with requirements for modifying the registry data. Establishing the regulations contract may occur in the same way as establishing the permissions contract. As explained, in embodiments in which the distributed ledger network is Ethereum, establishing the regulations contract may include publishing a transaction to the Ethereum network, where the transaction contains the program code of the regulations contract. In other distributed ledger networks, other ways of establishing a contract are possible.

As a general matter, the regulations contract may serve to provide the legal (or other administrative or regulatory) basis for changing the registry data. To that end, the regulations contract includes program code associated with requirements for modifying the registry data. In one implementation, these requirements may take the form of a list of rules whose conditions must be satisfied before certain registry data can be changed or in order to retain the current registry data. By way of example, in the context of a healthcare registry, the regulations contract may include an indication or indications that:
certain healthcare professionals must attain a certain number of professional education hours per year in order to renew their licensed status;
certain medical equipment must undergo a certain number of maintenance hours per month in order to retain its licensed status; and
certain healthcare professionals must may a certain fee every time period (e.g., every months) in order to maintain their licensed status.
   Other examples of requirements are possible as well.

As mentioned, the regulations contract contains program associated with requirements for modifying the registry data. In one implementation, the program code may contain instructions for determining (or facilitating a determination by another computing device (e.g., node 201)) whether certain registry data is permitted to be changed. More specifically, but still by way of example, the program code may be executed by a computing device (e.g., node 201) to receive an indication of a given request to modify certain registry data. The program code may be further executed by the computing device to make a determination, based on the regulations, whether the given request to modify the registry data is permitted. To facilitate this determination, the regulations contract may contain, or otherwise access, data storage that contains registration information. By way of example, registration information may include an indication or indications that:
“Healthcare Professional A” has paid registration fees for fiscal year 2018;
“Healthcare Professional B” has not obtained 10 hours of continuing education credit for 2019; and
“Equipment C” has undergone 20 maintenance hours in January 2018.
   Thus, in accordance with one example, to make a determination whether the given request to modify the registry data is permitted, the program code may be executed by the computing device to refer to this registration information and make a determination whether the registration information satisfies the regulations. If satisfied, the regulations contract permits the requested modification of registry data. If not satisfied, the regulations contract does not permit the requested modification of registry data. Other functions are possible as well.

Continuing at block 406, method 400 includes establishing, on the distributed ledger, a storage contract containing registry data and program code. Establishing the storage contract may occur in the same way as establishing the permissions contract and/or the regulations contract. As explained, in embodiments in which the distributed ledger network is Ethereum, establishing the storage contract may include publishing a transaction to the Ethereum network, where the transaction contains the program code of the storage contract. In other distributed ledger networks, other ways of establishing a contract are possible.

As a general matter, the storage contract may serve as the main storage platform of the registry system. In this way, the storage contract may contain, or otherwise refer to, data storage that contains the registry data of the registry system. The storage contract may also contain pointer data identifying where in the distributed ledger the permissions contract and the regulations contract reside. Moreover, the storage contract may also contain program code that facilitates accessing or modifying the registry data. To this end, the program code may be executed by a computing device (e.g., node 201) to receive an indication of a given request from a given user to modify certain registry data. The program code may be further executed by the computing device to call the permissions contract in order to facilitate a determination of whether the given user is permitted to make the requested modification. The program code may be further executed by the computing device to call the regulations contract in order to facilitate a determination of whether the requirements, if any, have been fulfilled. If both determinations are in the affirmative, then program code may be further executed by the computing device to make the requested change to the registry data.

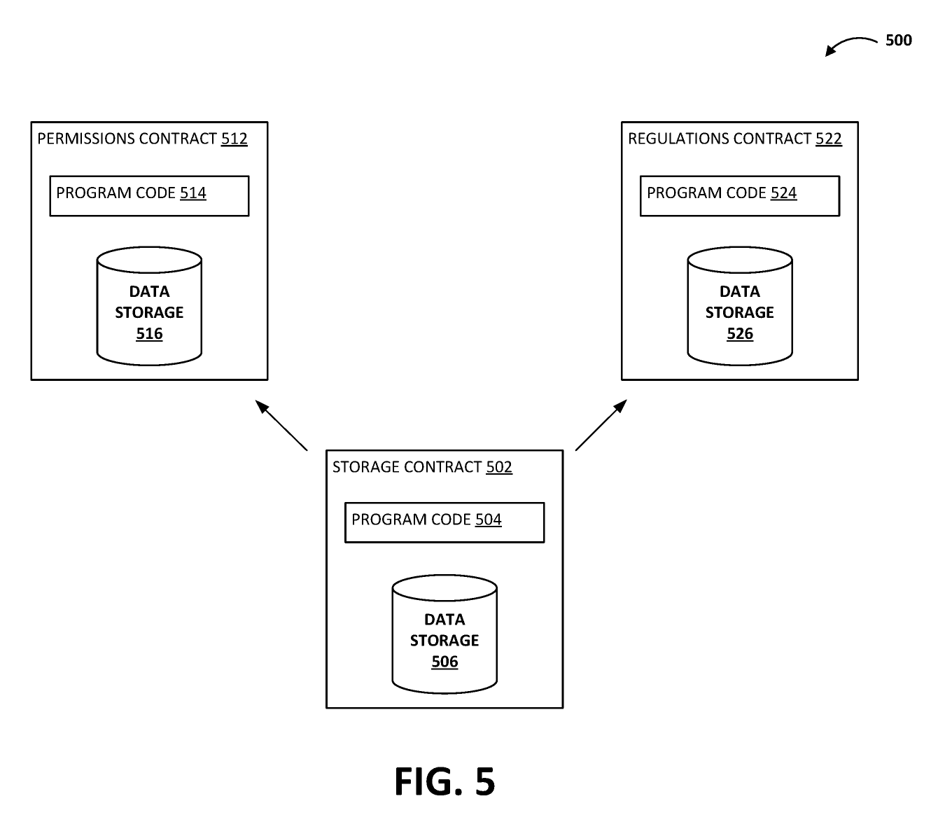

FIG. 5 depicts an example relationship 500 between a storage contract 502, permissions contract 512, and regulations contract 522, according to one embodiment of the distributed ledger registry system of the present disclosure. As depicted, the storage contract 502 contains program code 504 and data storage 506. In some embodiments, data storage 506 may contain the registry data of the registry system. Data storage 506 may also contain pointer data identifying the addresses which the permissions contract 512 and/or the regulations contract 522 can be called. Program code 504 may contain instructions executable by a computing device (e.g., computing device 201) to carry out the functions associated with the storage contract described above. For instance, in accordance with one example, program code 504 may contain instructions executable by the computing device to:
receive an indication of a given request from a given user to modify certain registry data in data storage 506;
call the permissions contract 512 in order to facilitate a determination of whether the given user is permitted to make the requested modification;
call the regulations contract 522 in order to facilitate a determination of whether the requirements, if any, have been fulfilled; and
make the requested change to the registry data in data storage 506.

As further depicted, the permissions contract 512 contains program code 514 and data storage 516. In some embodiments, data storage 516 may contain a list of user permissions. Program code 514 may contain instructions executable by a computing device (e.g., computing device 201) to carry out the functions associated with the permissions contract described above. For instance, in accordance with one example, program code 514 may contain instructions executable by the computing device to:
receive an indication of a given request from a given user to modify certain registry data in data storage 506;
refer to data storage 516 and make a determination, based on the user permissions stored in data storage 516, whether the given user is permitted to modify the registry data in accordance with the request; and
return to the storage contract an indication of whether the given user is permitted to modify the registry data in accordance with the request.

As further depicted, the regulations contract 522 contains program code 524 and data storage 526. In some embodiments, data storage 526 may contain a list of rules whose conditions must be satisfied before certain registry data can be changed. Data storage 526 may contain registration information as well. Program code 524 may contain instructions executable by a computing device (e.g., computing device 201) to carry out the functions associated with the regulations contract described above. For instance, in accordance with one example, program code 524 may contain instructions executable by the computing device to:
receive an indication of a given request from a given user to modify certain registry data in data storage 506;
refer to data storage 526 and make a determination, based on the rules and the registration data stored in data storage 526, whether the requested modification to the registry data is permitted; and
return to the storage contract an indication of whether the requested modification is permitted.

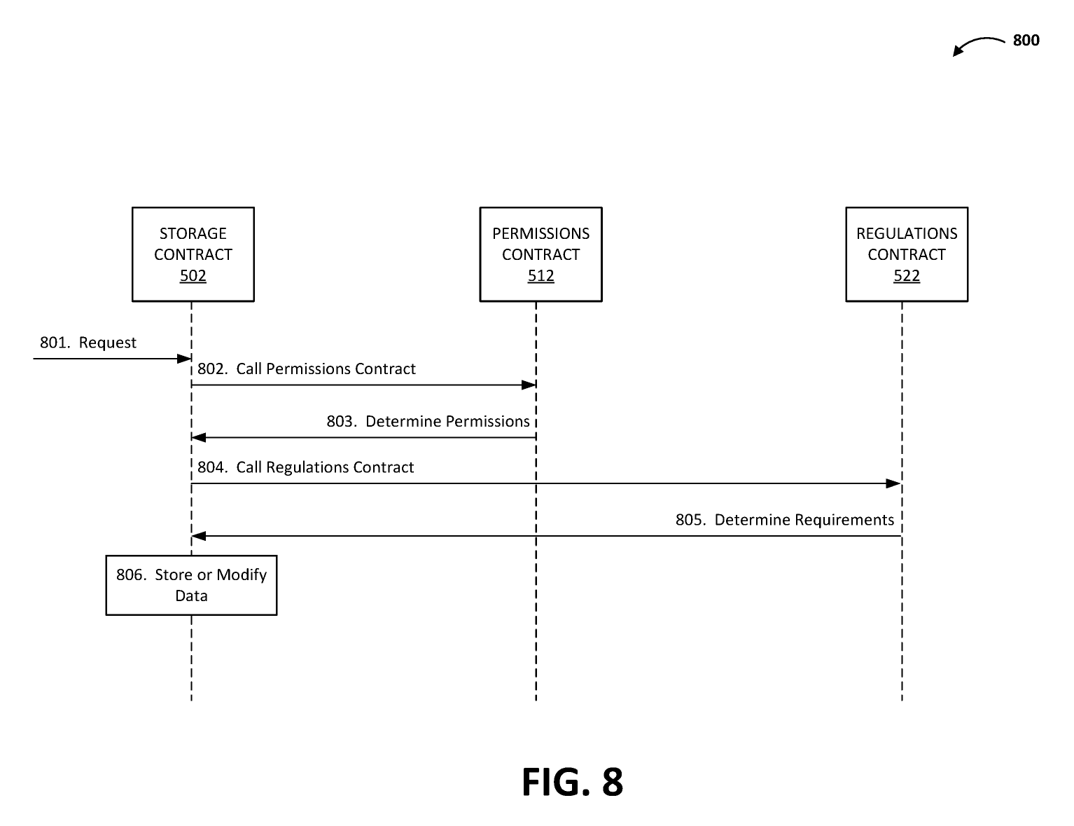

To help illustrate the functionality described above, FIG. 8 depicts an example message flow 800. The message flow 800 depicted in FIG. 8 is one example of a process that may be carried out in accordance with the present disclosure. As depicted, the example message flow begins with message 801 received by the storage contract 502 representing a request from a given user to modify certain registry data. The storage contract then calls the permissions contract 512 via message 802 in order to facilitate a determination of whether the given user is permitted to make the requested modification. The permissions contract 512 may refer to data storage and make a determination, based on the user permissions stored in data storage, whether the given user is permitted to modify the registry data in accordance with the request. Permissions contract 512 may return this determination to the storage contract 502 via a message 803.

Continuing, storage contract may call the regulations contract 522 via message 804 in order to facilitate a determination of whether the requirements, if any, have been fulfilled. The regulations contract may refer to data storage and make a determination, based on the rules and the registration data stored in data storage, whether the requested modification to the registry data is permitted. Regulations contract 522 may return this determination to the storage contract 502 via a message 805. The storage contract may then cause the registry data to be modified pursuant to the request via step 806. Of course, other examples are possible as well as modifications to message flow 800, including exchanging message in a different order than that depicted, or omitting some messages altogether.

The example arrangement 500 depicted in FIG. 5 and described by way of example in the forgoing may in some cases be modified. As described, there are advantages in deploying a registry system on a distributed ledger on which contracts are immutable, such as Ethereum. For instance, the program code's inability to change helps to prevent unauthorized access or unauthorized or illegal changes to the registry data, thus adding security to the registry system. But an inability to change program code may also render a distributed ledger registry system somewhat less adaptable in the event governmental regulations change or a system administrator desires to change an existing user's permissions or grant a new user access. The example arrangement 500 depicted in FIG. 5 and described by way of example in the forgoing may help overcome this problem.

More specifically, by distributing the functionality of the registry system across separate contracts, the example arrangement may facilitate updates to the user permissions and/or rules or regulations that govern the registry data. For instance, if it is desired that a user's permissions be updated or a new user added, then a new permissions contract can be established on the distributed ledger containing the desired change. Pointer data in data storage 506 in the storage contract 502 can then be updated to point to the new permissions contract. In this way, the user permissions can be updated while the remainder of the registry system remains undisturbed.

The regulations can be updated in a similar way. For instance, if governmental or other administrative regulations defining the registry data rules change, the registry system of the present disclosure can adapt. Specifically, in such a case (or for other reasons), a new regulations contract can be established on the distributed ledger containing the desired change. Pointer data in data storage 506 in the storage contract 502 can then be updated to point to the new regulations contract. In this way, the user regulations contract can be updated while the remainder of the registry system remains undisturbed.

In some embodiments, legacy data can be supported in the distributed ledger registry system of the present disclosure. As a general matter, legacy data (i.e., data taken from existing registry systems, such as registry systems that presently utilize the three-tier model, described above) can be a massive amount of data. Therefore, usual methods of storing legacy data in a distributed ledger registry system of the present disclosure may result in costly transactions and complicated storage procedures. Therefore, disclosed herein is an alternate mechanism for storing legacy data in the distributed ledger system of the present disclosure.

In particular, the legacy data can be stored in an off-ledger, yet still publicly-accessible location, such as in a cloud- or Internet-based data storage location. As used herein, data stored in the distributed ledger registry system is referred to as “on-ledger” data. Data stored outside the distributed ledger registry system, such as data stored in cloud storage or elsewhere, is referred to as “off-ledger” data. These legacy records are organized into a Merkle tree, and the Merkle root is stored in the storage contract of the distributed ledger registry system. As such, client access systems (described herein below) can download the off-ledger legacy data and compare it against the Merkle root stored in the immutable, on-ledger storage contract to verify its accuracy.

Modifications to the legacy data can be made by converting the portions of the legacy data into data that is stored in the storage contract in accordance with the methods set forth herein. Additionally or alternatively, the storage contract may contain specific functions, which when called, operate to submit a Merkle proof to the storage contract and, once verified, to store the legacy data in the data storage associated with the storage contract.

An embodiment of the present disclosure may thus include a process for initializing a distributed ledger registry system with legacy data. In one example, such a process may first include obtaining legacy data from an existing data registry system. The process may next include storing the legacy data in an off-ledger location, such a publicly-accessible, cloud storage location. The process may next include organizing the legacy data into a Merkle tree and computing a Merkle root of the Merkle tree. The process may next include storing the Merkle root in the distributed ledger registry system in accordance with the process described herein. This initialization process may facilitate access to the legacy data.

For instance, an embodiment of the present disclosure may include a process for presenting and modifying legacy data. In one example, such a process may begin with a client access device receiving a request to access certain legacy data. Responsive to receiving this request, the client access device may retrieve the off-ledger legacy data. The client access device may then arrange the retrieved legacy data into a Merkle tree or otherwise acquire a Merkle tree of the legacy data, such as by retrieving an already-computed Merkle tree. The client access device may then compute a Merkle root of the Merkle tree or otherwise acquire a Merkle root of the Merkle tree, such as by retrieving an already-computed Merkle root. The client access device may then retrieve from the distributed ledger, the stored Merkle root and compare it the computed (or otherwise retrieved) Merkle root. In this way, the client access device can confirm that the legacy data retrieved from the off-ledger storage location is accurate and has not, for instance, been tampered with. Any change to the off-ledger legacy data would result in a different Merkle root calculation; thus, a comparison with the Merkle root stored in the distributed ledger would yield a different result, thereby indicating a comprised version of the legacy data. As such, the client access device can present the legacy data to a user with the confidence that the legacy data, though stored off-ledger, is accurate.

An embodiment of the present disclosure may also include a process for converting certain legacy data into on-ledger registry data. In one example, such a process may begin with a client access device receiving a request to modify certain legacy data. Responsive to receiving this request, the client access device may then, in accordance with the processes disclosed herein, cause a new record to be added to the registry reflecting the requested modification. Such a record would, as a result, no longer be a legacy record, and would instead be a part of the on-ledger registry. To help mitigate any confusion, the client access device may then cause the off-ledger legacy data to be modified to remove the record or records now existing in the on-ledger registry. This process may further include, computing a new Merkle tree of the modified legacy data, followed by computing a new Merkle root of the modified legacy data. Finally, the process may conclude causing the on-ledger registry system to store the new Merkle root in accordance with the process described herein. Those of skill in the art will understand that modifications to the forgoing example processes may be made, which are nonetheless within the scope of the present disclosure.

Turning now to FIG. 6, method 600 includes steps depicted by blocks 602, 604, 606 and 608, which, in one implementation, facilitates access to and modification of the data in a distributed ledger registry system. Method 600 may be carried out by a client station desiring to access a distributed ledger registry system. Beginning at block 602, method 600 includes receiving, at or from a client station, a request of a given user to make a given type of modification to registry data. The client station may be any computing system with access to the distributed ledger containing the registry system (e.g., nodes 201, 202, and/or 203). In some embodiments, the client system may present the user with a user interface in order for the user to interact with the registry system. Through the user interface, for instance, the user may request to view all or part of the registry data, change all or part of the registry data, or other similar functions.

At block 604, the method 600 includes facilitating execution of the permissions contract to determine that the given user is permitted to make the given type of modification to the registry data in the storage contract. In some implementations, this includes calling the storage contract in the distributed ledger registry system. As explained above, in embodiments in which the distributed ledger is Ethereum, calling the storage contract, may be carried out by sending a transaction to the address of the storage contract. This may cause the nodes (e.g., nodes 201, 202, and/or 203) validating the transactions and generating the Ethereum blockchain to execute the storage contract. In accordance with the examples described above, the storage contract calls and therefore causes the permissions contract to be executed. And as also described above, execution of the permissions contract facilitates a determination that the given user is permitted to make the given type of modification to the registry data in the storage contract.

At block 606, method 600 includes facilitating execution of the regulations contract to determine whether the given type of modification to the registry data is permitted. Like in block 604, in some implementations, this includes calling the storage contract in the distributed ledger registry system. As explained above, the storage contract, in addition to calling and executing the permissions contract, also calls and executes the regulations contract. And as also described above, execution of the regulations contract facilitates a determination that the given type of modification to the registry data is permitted.

At block 608, the method 600 includes facilitating modification of the registry data in the storage contract in accordance with the received request. As explained, when the storage contract receives indications, as a result of calling and executing the permissions and regulations contracts, that the given user is permitted to make the given type of modification to the registry data in the storage contract and that the given type of modification to the registry data is permitted, the storage contract causes the given modification to the registry data in the storage contract's data storage.

Notably, storage of data via smart contract implementations as discussed elsewhere herein is not typically optimized natively on the blockchain for client utility. In other words, smart contract data is usually stored in a way that is not ideal for retrieval and viewing by a client. Indeed, Blockchain queries are asynchronous in nature and most client requests will require large numbers of queries to fulfill a given data request. Hence, as discussed further below, it would be advantageous to implement a new query technique that enables blockchain queries to be performed in parallel.

To facilitate retrieving and modifying data from the distributed ledger registry system and displaying this data for a user of the distributed ledger registry system, disclosed herein are additional functions and systems that may help to carry out multitasking and complex data transformation on blockchain query results. These additional functions and features are referred to herein as a client access system. The client access system may be provided by an access device, such as access device 220 described herein with reference to FIG. 2. In accordance with one embodiment, client access device 220 may include a GUI operable by a user to make requests to access or modify data stored in the distributed ledger registry system or legacy data, as described herein. Responsive to receiving such requests, the client access system may directly or indirectly communicate with one or more of nodes 201, 202, and/or 203 via communication network(s) 250 in order to request data from or issue requests to the distributed ledger.

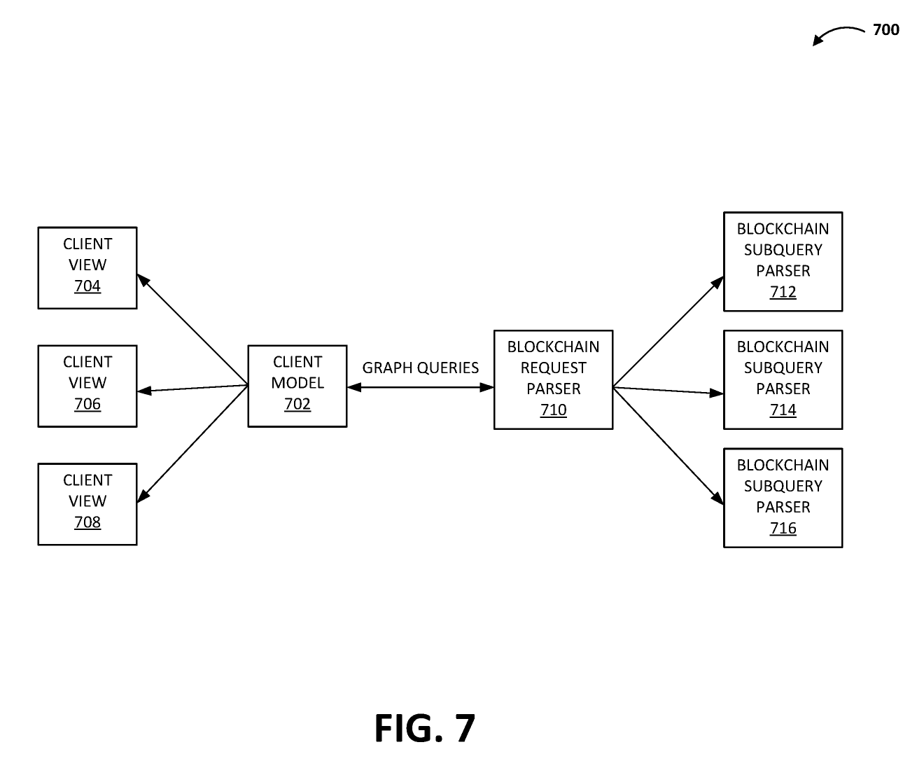

More specifically, but still by way of example, the client access system of the present disclosure may be arranged with a system architecture according to the example architecture 700 depicted in FIG. 7. As depicted, the client access system includes a client model 702 and a blockchain request parser 710. The client model can provide data in several client views 704, 706, and 708. In order to efficiently query the blockchain (or other distributed ledger), the client access system utilizes a blockchain request parser 710 that operates to split the query into several subquery parsers 712, 714, and 716. By splitting requests into subqueries, the client access system can facilitate a more efficient query of data located in contract data storage, such as that described above.

More particularly, but still by way of example, when a client model 702 receives requests from users at client stations requesting data stored in blockchains, the client model 702 uses a handler that describes the data using graph queries. Graph queries are an efficient data query format that allows for deeply nested requests involving multiple nested client components. These nested client components make up views of the data presented to the user. By way of example, GraphQL may be used. Graph queries efficiently allow the client access system to take information from the blockchain and update the client model with the many data transformations that may result from querying a blockchain.

To engage in graph query requests, the client model 702 may utilize javascript and several blockchain query parsers (e.g., parser 710) and subquery parsers (e.g., subquery parsers 712, 714, and 716) that resolve queries against the blockchain. Each subquery may involve one or more independent data requests against the blockchain. In some implementations, these queries are processed in parallel in order to achieve desirable responsiveness.

Example implementations of the client access system are programmed according to the example architecture depicted in FIG. 7 using clojurescript as opposed to raw javascript. In this way, it is possible to use communicating sequential processes (CSP) channels via the clojure core.async library, which may enable multiple concurrent blockchain data requests in parallel as depicted by the subquery parsers 712, 714, and 716. The result of the parallel subqueries may then be combined to fulfill client data requests in a highly efficient manner.

The present disclosure is not to be limited in terms of the particular implementations described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example implementations described herein and in the Figures are not meant to be limiting. Other implementations can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The particular arrangements shown in the figures should not be viewed as limiting. It should be understood that other implementations can include more or less of each element shown in a given figure. Further, some of the illustrated elements can be combined or omitted. Yet further, an example implementation can include elements that are not illustrated in the figures.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims.

I claim:

1. A system comprising:
a computing device containing one or more processors and non-transitory data storage, the non-transitory data storage having stored therein:
a portion of a distributed ledger, the distributed ledger containing a storage contract containing registry data, a permissions contract containing program code associated with user permissions for modifying the registry data, and a regulations contract containing program code associated with requirements for modifying the registry data; and
program code, which when executed by the computing device, causes the computing device to:
execute the permissions contract to facilitate a determination that a given user is permitted to make a given type of modification to the registry data in the storage contract,
execute the regulations contract to facilitate a determination that the given type of modification to the registry data is permitted; and
modify the registry data in the storage contract in accordance with a modification requested by the given user.

2. The system of claim 1,
wherein the program code causes the computing device to modify the registry data in the storage contract only after (i) responsive to executing the permissions contract, determining that the given user is permitted to make a given type of modification to the registry data in the storage contract, and (ii) responsive to executing the regulations contract determining that the given type of modification to the registry data is permitted.

3. The system of claim 1, wherein the distributed ledger further contains data storage associated with the storage contract, and wherein the data storage associated with the storage contract has stored therein first address information that identifies a location in the distributed ledger at which the permissions contract can be addressed, and second address information that identifies a location in the distributed ledger at which the regulations contract can be addressed.

4. The system of claim 3, wherein the computing device has stored therein additional program code, which when executed by the computing device, causes the computing device to:
generate a new permissions contract; and
revise the first address information to identify a location in the distributed ledger at which the new permissions contract can be addressed.

5. The system of claim 3, wherein the computing device has stored therein additional program code, which when executed by the computing device, causes the computing device to:
generate a new regulations contract; and
revise the second address information to identify a location in the distributed ledger at which the new regulations contract can be addressed.

6. The system of claim 1, wherein the computing device has stored therein additional program code, which when executed by the computing device, causes the computing device to:
receive from a given user at a client station a request for output of a portion of the registry data,
execute the permissions contract to facilitate a determination that the given user is permitted to receive the requested output, and
return to the client station the requested portion of the registry data.

7. A non-transitory computer readable medium (CRM) having program code stored thereon, which when executed by a computing device causes the computing device to carry out operations including:
facilitating access to a distributed ledger, the distributed ledger containing a storage contract containing registry data, a permissions contract containing program code associated with user permissions for modifying the registry data, and a regulations contract containing program code associated with requirements for modifying the registry data;
receiving, from a client station, a request of a given user to make a given type of modification to registry data;
facilitating execution of the permissions contract to determine that the given user is permitted to make the given type of modification to the registry data in the storage contract,
facilitating execution of the regulations contract to determine whether the given type of modification to the registry data is permitted; and
facilitating modification of the registry data in the storage contract in accordance with the received request.

8. The CRM of claim 7, wherein facilitating execution of the permissions contract or the regulations contract comprises publishing, to a network that hosts the distributed ledger, a transaction.

9. The CRM of claim 7, wherein the program code facilitates modification of the registry data in the storage contract in accordance with the received request only after (i) a first determination that the given user is permitted to make a given type of modification to the registry data in the storage contract, wherein the first determination is responsive to an execution of the permissions contract, and (ii) a second determination that the given type of modification to the registry data is permitted, wherein the second determination is responsive to an execution of the permissions contract.

10. The CRM of claim 7, wherein the distributed ledger further contains data storage associated with the storage contract, and wherein the data storage associated with the storage contract has stored therein first address information that identifies a location in the distributed ledger at which the permissions contract can be addressed, and second address information that identifies a location in the distributed ledger at which the regulations contract can be addressed.

11. The CRM of claim 10, wherein the operations further include:
facilitating generation of a new permissions contract; and
facilitating revision of the first address information to identify a location in the distributed ledger at which the new permissions contract can be addressed.

12. The CRM of claim 10, wherein the operations further include:
facilitating generation of a new regulations contract; and
facilitating revision of the second address information to identify a location in the distributed ledger at which the new regulations contract can be addressed.

13. The CRM of claim 7, wherein the operations further include:
receiving, from the client station, a request of the given user for output of a portion of the registry data,
facilitating execution of the permissions contract to determine that the given user is permitted to receive the requested output, and
facilitating a return to the client station of the requested portion of the registry data.

14. A method comprising:
establishing, on a distributed ledger, a permissions contract containing program code associated with user permissions for modifying the registry data;
establishing, on the distributed ledger, a regulations contract containing program code associated with requirements for modifying the registry data;
establishing, on the distributed ledger, a storage contract containing registry data and program code, which when executed by a computing device would cause the computing device to:
execute the permissions contract to determine that a given user is permitted to make the given type of modification to the registry data in the storage contract,
execute the regulations contract to determine whether the given type of modification to the registry data is permitted; and
modify the registry data in the storage contract in accordance with a request.

15. The method of claim 14, wherein the program code causes the computing device to modify the registry data in the storage contract only after, responsive to executing the permissions contract, determining that the given user is permitted to make a given type of modification to the registry data in the storage contract.

16. The method of claim 14, wherein the program code causes the computing device to modify the registry data in the storage contract only after, responsive to executing the regulations contract determining that the given type of modification to the registry data is permitted.

17. The method of claim 14, wherein the distributed ledger further contains data storage associated with the storage contract, and wherein the data storage associated with the storage contract has stored therein first address information that identifies a location in the distributed ledger at which the permissions contract can be addressed.

18. The method of claim 14, wherein the distributed ledger further contains data storage associated with the storage contract, and wherein the data storage associated with the storage contract has stored therein second address information that identifies a location in the distributed ledger at which the regulations contract can be addressed.

19. The method of claim 17, further comprising:
establishing on the distributed ledger, a new permissions contract; and
revising the first address information to identify a location in the distributed ledger at which the new permissions contract can be addressed.

20. The method of claim 18, further comprising:
generating a new regulations contract; and
revising the second address information to identify a location in the distributed ledger at which the new regulations contract can be addressed.
